(19) United States
(12) Patent Application Publication
(10) Pub. No.: US 2009/0321411 A1
(43) Pub. Date: Dec. 31, 2009

(54) Baking oven

(76) Inventor: Michael Koos, Arnstein (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/311,132

(22) PCT Filed: Sep. 14, 2007
(86) PCT No.: PCT/EP2007/059684

§ 371 Date: Mar. 19, 2009

(30) Foreign Application Priority Data
Sep. 19, 2006 (DE) 10 2006 044593.7

(51) Int. Cl. A21B 1/26

(52) U.S. Cl. 219/400

(57) ABSTRACT

A baking oven has a housing, a fan situated in the upper and/or side area of the housing, a heating register and a baking chamber which is bordered by a side wall having inlet openings and through which heated air flows. The air heated by the heating register flows through the inlet openings into the baking chamber. At least one flow guidance device is provided which conducts the air heated by the heating register toward the lower area of the wall having inlet openings to counteract thermal stratification in the baking chamber that can result in a baking chamber temperature that is higher in the upper area than in the lower area

### TECHNICAL FIELD

The present invention relates to a baking oven having a housing, a fan situated in the upper and/or lateral area of the housing, a heating register and a baking chamber, which is bordered by a side wall having inlet openings and through which heated air flows, air heated by the heating register flowing through the inlet openings into the baking chamber.

The present invention relates in particular to a baking oven for insertion of a baking cart, also known as a multi-tray cart. Such baking ovens allow bakers to simultaneously bake a large number of baked goods situated on multiple baking trays of the baking cart situated one above the other. The baking carts have rollers which stand on the floor. The baking carts are pushed through an oven door into the baking chamber of the baking oven. For this reason, the functional elements of the baking oven are to be situated above or at the side of the baking chamber.

### BACKGROUND INFORMATION

Such a baking oven by the present applicant is known from DE 101 48 548 A1, for example. The fan and the heating register with this oven are situated above the baking chamber. Heated air flows through the heating register into an inflow channel provided at the side of the baking chamber. A wall bordering the inflow channel toward the baking chamber has the inlet openings. Furthermore, in the inflow channel there is a vapor apparatus to which water may be supplied and then evaporated by the vapor apparatus, thereby increasing the atmospheric humidity within the baking chamber.

Similar baking ovens for multi-tray carts are known from the documents DE 28 47 963 and EP 0 909 533.

One problem with such ovens is the stratification of different temperature zones inside the baking chamber. Colder air essentially has a greater density than warmer air. The air with the highest density and the lowest temperature is near the bottom of the baking chamber. Air having the lowest density and the highest temperature is in the upper area of the baking chamber. The temperature differences between the hottest and coldest locations in the baking chamber may amount to several tens of degrees C. and is consequently on the order of magnitude of 10% to 25% of the temperature in ° C., i.e., the temperature above the freezing point of water. This thermal stratification may result in irregular baking results. Baked goods in the upper, hotter area of the baking chamber are completely baked much more rapidly than baked goods in the lower, colder area of the baking chamber.

### DISCLOSURE OF THE INVENTION

The object of the present invention is to counteract thermal stratification in the baking chamber.

This object is achieved according to the present invention by providing at least one flow guidance means which conducts the air heated by the heating register toward the lower area of the wall having flow openings.

This measure results in the air that has the highest temperature flowing from the heating register toward the wall having inlet openings, through the lower area of this wall into the baking chamber. With a baking oven of the type described here, the heated air is usually directed to a chamber or a channel, which extends essentially over the entire surface of the wall having inlet openings. The wall of the baking chamber usually has a lower temperature than the air heated by the heating register. Consequently, the heated air releases heat toward the wall of the baking chamber. Since the heated air flows from the bottom up toward the wall having inlet openings, it has the highest temperature in the lower area of this wall. This temperature drops toward the top of the oven to the extent that the air releases thermal energy toward the wall having inlet openings.

Consequently, the air flowing into the baking chamber has a higher temperature in the lower area than the air flowing into the baking chamber through the upper openings. This inverted temperature stratification at the moment of inflow results in a buoyancy of the air flowing in at the bottom which is hotter, has a lower density and is therefore lighter than the air flowing in at the top. This re-stratification of the air as it flows through the baking chamber results in a very homogeneous temperature distribution during the baking process.

Baking ovens according to the present invention may in practice have a vapor apparatus which is situated parallel and next to the wall having inlet openings. The vapor apparatus is usually made up of U-shaped elongated iron sections into which water is introduced. The vapor apparatus is heated by the hot air flow in the baking oven to a temperature well above 100° C. For this reason, water introduced into the vapor apparatus evaporates. This water vapor flows with the heated air through the inlet openings into the baking chamber and has a positive effect on the baking results. The vapor apparatus is situated parallel and next to the wall having inlet openings outside of the baking chamber, so the air from the heating register flows against the vapor apparatus from below. With the baking ovens known in the past, the vapor apparatus as well as the wall having inlet openings is usually exposed to oncoming flow from above (cf. DE 101 48 548 A1), so that the incoming flow of hot air has heated the upper areas the most, namely where the hottest temperature already prevails due to the natural convection because of the decreasing density of hot air. With baking ovens known in the past, this resulted in the vapor apparatus having a substantial temperature gradient over its height. The water supplied to the upper vapor iron sections would evaporate more rapidly than the water supplied to the lower colder vapor iron sections. This tendency is now counteracted because the vapor apparatus is also exposed to an oncoming flow of heated fresh air from below.

In practice, the vapor apparatus may be located in an inflow channel outside of the baking chamber and adjacent to the wall having inlet openings. Furthermore, the heating register may be situated at the side next to the inflow channel. The heating register transfers its heat in this case not only to the air flowing through the heating register but also to the neighboring inflow channel with the vapor apparatus situated therein.

In practice, the inflow channel may be separated from the heating register by a flow baffle, at least one opening in the lower section of the flow baffle connecting the inflow channel to the heating register. The flow baffle forms the flow guidance means, ensuring that the air flowing from the fan through the heating register to the baking chamber flows into the inflow channel at the bottom, bordered by the wall having inlet openings. A closing device may be provided to selectively open or close the opening in the lower area of the flow baffle. This causes the heating register and the fan to be separated from the baking chamber. This is advantageous in particular when exposing the baked goods to water vapor.

In a practical embodiment of the baking oven, a flow channel above the top of the baking chamber may lead from the fan to the upper end of the heating register. The lower area of the wall having inlet openings may be connected to the lower end of the heating register. As mentioned previously, the flow baffle, whose opening in the lower area allows an influx of heated air into the inflow channel, is situated between the heating register and the inflow channel, which is adjacent to the wall having inlet openings.

The ovens described here are frequently operated with a gas burner or an oil burner. In this case the burner, which heats the heating register, may be situated beneath the heating register. The burner, which is the hottest location in the baking oven, is situated in the lower area at the side of the baking chamber, in particular at the side of the inflow channel, in which the vapor apparatus is situated. The heat of the burner consequently heats in particular the lower section of the vapor apparatus and the air before it flows into the inflow channel. Situating the burner in the lower area of the baking oven also results in an inverted thermal stratification in which the hottest air flows into the baking chamber at the bottom. Furthermore, the additional heating of the vapor iron sections in the lower area by the burner has the effect that no temperature gradient with a declining temperature toward the bottom prevails in the vapor apparatus. The lower vapor iron sections tend to have a higher temperature than the upper ones.

In practice, a cross-flow fan is preferably used as the fan in the baking oven according to the present invention. Such cross-flow fans are low maintenance, generate little noise during operation and work very reliably in general. In practice, the cross-flow fan may extend over the entire width of the baking chamber. This makes it possible to achieve the greatest possible volume flow, which flows uniformly through the entire volume of the baking chamber. Thus zones of reduced temperature through which the fan delivers only a very low volume flow may be prevented within the baking chamber.

In practice the fan may be installed above a top wall of the baking chamber, so that outlet openings for the outlet of air from the baking chamber may be provided in the top wall. According to DE 101 48 548 A1 by the present applicant, the openings in the top wall may be closable by a slide valve so that the cross section of the openings is continuously adjustable. At a constant drive power of the fan, the flow rate of air leaving the baking chamber may be controlled by varying the cross section of the openings. In this way, the flow rate of air into the baking chamber and thus the temperature inside the baking chamber are influenced at the same time. In practice, the openings in the top wall of the baking chamber may be completely closable if the baking chamber is to be separated from the fan with the heating register.

The slide valve then forms a closing device together with the aforementioned flap for closing the opening of the inflow channel, thereby allowing the baking chamber to be tightly sealed.

### BRIEF DESCRIPTION OF THE DRAWINGS

One embodiment of the present invention is described in greater detail below with reference to the accompanying drawings.

FIG. 1 shows a front view of a baking oven according to the present invention,

FIG. 2 shows a sectional view of a baking oven with the baked goods carrier situated therein, and

FIG. 3 shows a view corresponding to FIG. 2 of the guidance device for the air flow in the baking oven from FIGS. 1 and 2.

### EMBODIMENT(S) OF THE INVENTION

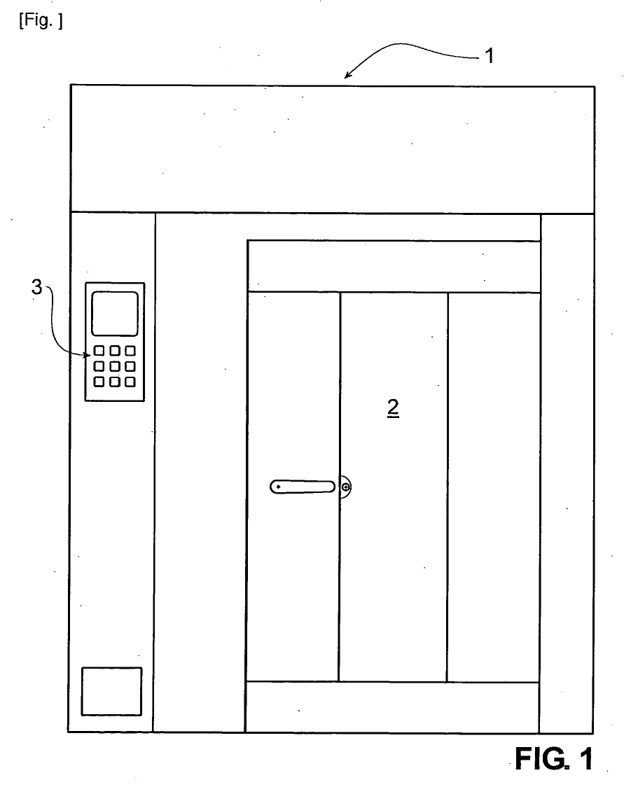

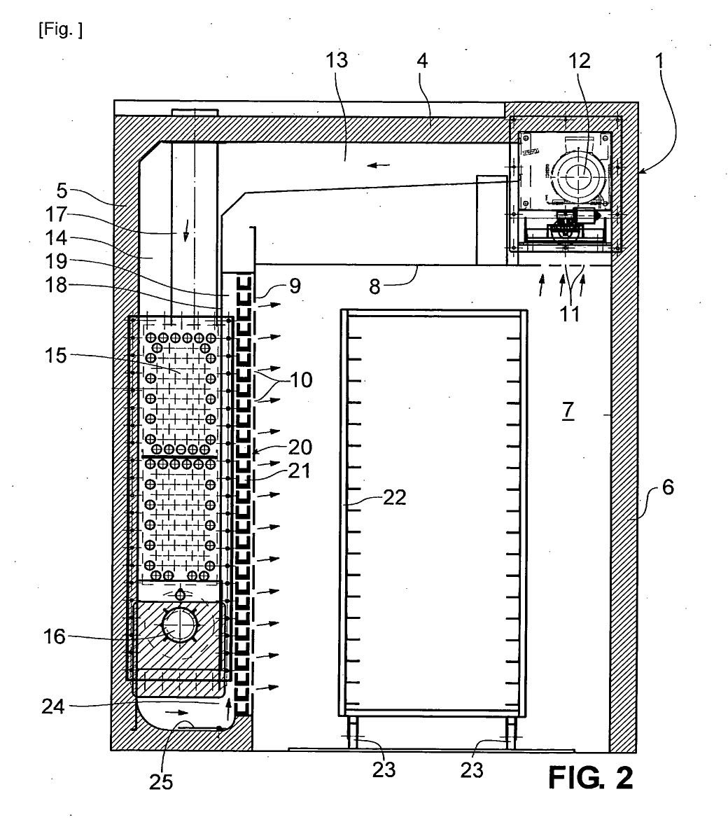

FIG. 1 shows a baking oven according to the present invention, which is usually used in bakeries or in factories for baked goods. The baking oven includes a housing 1 having a door 2, which is closed during the baking operation and may be opened to introduce and remove the baked goods. Door 2 is approximately 2 meters high and extends all the way to the floor without a threshold. This ensures that a baking cart, i.e., a multi-tray cart 22 (see FIG. 2) may also be inserted into baking chamber 7 of the baking oven through the door opening when door 2 is opened. FIG. 1 also shows an operating field 3 having a display screen. Parameters of the baking operation (e.g., duration, temperature, humidity) may be input via operating field 3 and then be displayed for monitoring purposes via the display screen of operating field 3.

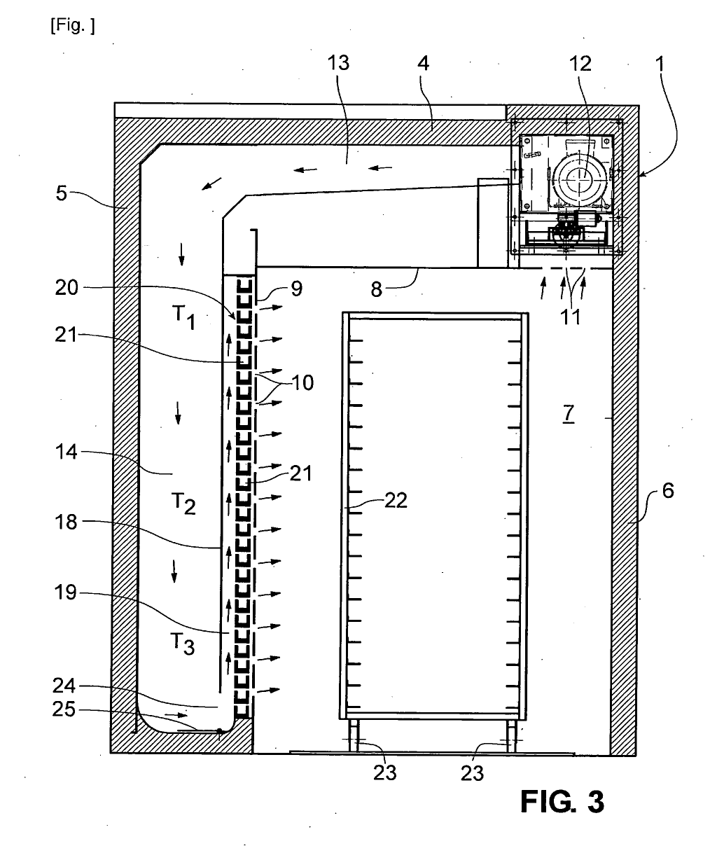

As is apparent in the sectional diagrams in FIGS. 2 and 3, housing 1 includes a thermally insulating top wall 4 and thermally insulating side walls 5, 6. A baking chamber 7 is formed inside thermally insulating walls 4 to 6 of housing 1. Baking chamber 7 is bordered at the top by a cover wall 8 and at the sides by a side wall 9. Cover wall 8 and side walls 9 of baking chamber 7 are usually formed by a steel plate made of stainless steel. Inlet openings 10 through which heated air flows into baking chamber 7 are situated in side wall 9. Cover wall 8 contains outlet openings 11 through which air flows out of baking chamber 7.

Above cover wall 8 and in particular above outlet openings 11, a fan 12 is situated in the upper right corner of housing 1. Fan 12 is a cross-flow fan, which extends over the entire width of baking oven housing 1, perpendicular to the plane of the drawing in FIGS. 2 and 3. In the right area of cover wall 8, fan 12 thus extracts air through outlet openings 11 over the total width of baking chamber 7. A horizontal flow channel 13 running essentially parallel to top wall 4 of the housing is connected to fan 12. A vertical flow channel 14, in which heating register 15 and burner 16 are situated, is connected to horizontal flow channel 13. Furthermore, exhaust pipe 17 of burner 16 is visible in FIG. 2.

As indicated by the arrows in FIGS. 2 and 3, the air output by fan 12 flows at first horizontally from right to left essentially parallel to top wall 4 of housing 1 and then vertically from top to bottom essentially parallel to left side wall 5 of housing 1. In its downward movement, the air is heated by heating register 15 and burner 16. In FIG. 3, which does not show the burner and heating register in order to make the flow paths more discernible, it may be seen that the air has different temperatures T₁, T₂ and T₃ at the various heights of vertical flow channel 14. Temperature T₁ above the heating register 15 is the lowest. In the heating register 15, temperature T₂ of the air is definitely elevated. Below the heating register in the area of the burner, the air has its highest temperature T₃. The temperature differences between temperatures T₁ and T₂ and between temperatures T₂ and T₃ may be on the order of magnitude between 50° C. and 100° C.

As may be seen in FIG. 3 in particular, a flow baffle 18 is provided between wall 9 of baking chamber 7 and vertical flow channel 14. Flow baffle 18 separates wall 9 of baking chamber 7 having inlet openings 10 from flow channel 14 in which the heating register is situated. A narrow inflow channel 19 is defined between flow baffle 18 and wall 9 of baking chamber 7. A vapor apparatus 20 having approximately 30 elongated U-shaped vapor iron sections 21 situated one above the other is provided in inflow channel 19.

As FIG. 2 shows, flow baffle 18 forms a side wall of the housing over a large portion of its length, enclosing heating register 15 and burner 16. Flow baffle 18 is consequently heated by burner 16 and heating register 15 and in this way heats inflow channel 19. Furthermore, vapor apparatus 20 is heated by burner 16 and heating register 15 by thermal conduction of the essentially metallic components but also by thermal radiation.

The location of heating register 15 and burner 16 in immediate proximity of vapor apparatus 20 thus causes vapor apparatus 20 to be heated not only by the air circulating around it but also directly by burner 16 and heating register 15. In other words, the hottest part of the heating system, namely burner 16, is situated in the lowest area of the baking oven. Furthermore, the hottest air, namely the air coming out of burner 16, enters inflow channel 19 from below, and flows from there into baking chamber 7. On the path upward, the air cools off slightly. However, the cooling is limited because flow baffle 18 bordering inflow channel 19 is kept at an elevated temperature by its immediate proximity to burner 16 and heating register 15. Since the wall of inflow channel 19 formed by flow baffle 18 is kept at the highest temperature in the lower area by hot burner 16 and since the air at the highest temperature flows into the lower area of inflow channel 19, the temperature gradient of the air flow entering baking chamber 7 increases from top to bottom. In other words, air flowing into chamber 7 at the top has a lower temperature than air flowing into baking chamber 7 at the bottom. The fact that the hottest air flows into the lower area of baking chamber 7 results in a natural convection, i.e., the rise of the hot air flowing in at the bottom having a lower density than the colder air flowing in at the top. In this way, a continuous circulation of air in baking chamber 7 and consequently a much smaller temperature difference is achieved over the height of the baking chamber.

Finally, FIGS. 2 and 3 show a baking cart 22, also known as a multi-tray cart. Multi-tray cart 22 has rollers 23 with which it may be pushed into baking chamber 7 and out of baking chamber 7. A plurality (18 here) of baking trays on which baked goods are placed may be situated one above the other on baking cart 22.

The oven according to the present invention may have a device (not shown) for lifting and rotating baking cart 22. These devices are known from the related art and need not be described further here.

FIG. 3 shows in particular that lower opening 24 through which the heated air flows out of vertical flow channel 14 into inflow channel 19 is closable by a flap 25. In the same way, outlet openings 11 through which air flows out of baking chamber 7 to fan 12 are closable by a slide valve (not shown). If openings 24 leading into inflow channel 19 as well as outlet openings 11 of baking chamber 7 are closed, baking chamber 7 is tightly sealed with respect to fan 12 and heating register 15.

### LIST OF REFERENCE NUMERALS

1 housing
2 door
3 operating field
4 top wall
5 side wall
6 side wall
7 baking chamber
8 cover wall
9 side wall
10 inlet opening
11 outlet opening
12 fan
13 horizontal flow channel
14 vertical flow channel
15 heating register
16 burner
17 exhaust pipe
18 flow baffle, flow guidance means
19 inflow channel
20 vapor apparatus
21 vapor iron sections
22 baking cart
23 roller
24 opening
25 closing device, flap

1. A baking oven, comprising:
a housing;
a fan situated in at least one of: an upper and a side area of the housing;
a heating register;
a baking chamber through which air heated by the heating register flows and which is bordered by a wall having inlet openings, the air heated by the heating register flowing through the inlet openings into the baking chamber; and
at least one flow guidance device which guides the air heated by the heating register to a lower area of the wall having the inlet openings.

2. The baking oven as recited in claim 1, further comprising:
a vapor apparatus which is situated parallel to and next to the wall having the inlet openings.

3. The baking oven as recited in claim 2, wherein the vapor apparatus is situated in an inflow channel that is outside of the baking chamber and adjacent to the wall having the inlet openings.

4. The baking oven as recited in claim 3, wherein the heating register is situated at the side next to the inflow channel.

5. The baking oven as recited in claim 4, wherein the inflow channel is separated from the heating register by a flow baffle, at least one opening in a lower section of the flow baffle connecting the inflow channel to the heating register.

6. The baking oven as recited in claim 1, further comprising:
a flow channel that leads from the fan to the upper end of the heating register, and the lower area of the wall having inlet openings is connected to the lower end of the heating register.

7. The baking oven as recited in claim 1, further comprising:
a burner which heats the heating register and which is situated below the heating register.

8. The baking oven as recited in claim 1, wherein the fan is a cross-flow fan.

9. The baking oven as recited in claim 1, wherein the fan extends over the entire width of the baking chamber.

10. The baking oven as recited in claim 1, wherein the fan is situated above a cover wall of the baking chamber, and outlet openings for the air to escape from the baking chamber are provided in the cover wall.

11. The baking oven as recited in claim 1, further comprising:
at least one closing device for tightly sealing the baking chamber.

12. A baking oven, comprising:
a housing;
a heating unit;
a baking chamber disposed in the housing, wherein air heated by the heating unit flows into the baking chamber through a wall having inlet openings, the wall having an upper area and a lower area corresponding to an upper area and a lower area of the baking chamber; and
at least one flow guidance device which guides the air heated by the heating unit to the lower area of the wall having the inlet openings.

13. The baking oven as recited in claim 12, further comprising:
a fan disposed in at least one of: an upper area and a side area of the housing.

14. The baking oven as recited in claim 12, further comprising:
a vapor apparatus which is situated parallel to and next to the wall having the inlet openings.

15. The baking oven as recited in claim 14, wherein the vapor apparatus is situated in an inflow channel that is outside of the baking chamber and adjacent to the wall having the inlet openings.

16. The baking oven as recited in claim 15, wherein the inflow channel is separated from the heating unit by a flow baffle, at least one opening in a lower section of the flow baffle connecting the inflow channel to the heating register.

17. The baking oven as recited in claim 12, further comprising:
a flow channel that leads from the fan to the upper end of the heating register, and the lower area of the wall having inlet openings is connected to the lower end of the heating register.

18. The baking oven as recited in claim 12, wherein the fan is at least one of the following: a cross-flow fan, a fan that extends over the entire width of the baking chamber, and situated above a cover wall of the baking chamber, the cover wall including outlet openings for the air to escape from the baking chamber.

19. The baking oven as recited in claim 12, further comprising:
at least one closing device that seals the baking chamber.
